(19) United States
(12) Patent Application Publication
(10) Pub. No.: US 2007/0039799 A1
(43) Pub. Date: Feb. 22, 2007

(54) Roller track assembly

(75) Inventor: Richard Minchey, Goodlctsville, TN (US)

Correspondence Address: WOOD, PHILLIPS, KATZ, CLARK & MORTIMER, 500 W. MADISON STREET, SUITE 3800, CHICAGO, IL, 60661, US

(73) Assignee: Unarco Material Handling, Inc.

(21) Appl. No.: 11/208,449

(22) Filed: Aug. 19, 2005

(51) Int. Cl. B65G 13/00

(52) U.S. Cl. 193/35 R

(57) ABSTRACT

A roller track assembly comprises a first roller track, a second roller track, and a linking roller track, which links the first and second roller tracks. Each of the first and second roller tracks comprises two side walls and plural. The linking roller track comprises two side walls and a roller or plural rollers. Each roller has an axis and is supported between the side walls of the roller track having such roller so as to be freely rotatable about the axis of such roller. Each side wall of the linking roller track has a first extension, which is attached to an end portion of a respective one of the side walls of the first roller track, via bolts passing through an elongate slot in the first extension. Each side wall of the linking roller track has a second extension, which is attached to an end portion of an associated one of the side walls of the second roller track, via bolts passing through an elongate slot in the second extension.

### TECHNICAL FIELD OF THE INVENTION

This invention pertains to a roller track assembly of a type comprising plural roller tracks, which are linked end-to-end to one another.

### BACKGROUND OF THE INVENTION

Roller track assemblies of the type noted above are exemplified in U.S. Pat. No. 978,466, No. 4,366,894, and No. 6,510,935 B1. As exemplified therein, the roller tracks are linked end-to-end, via bars, plates, or splices, which are fastened, as by being bolted, to the side walls of the roller tracks being linked.

### SUMMARY OF THE INVENTION

This invention provides a roller track assembly of the type noted above but of an improved construction, wherein the roller track assembly comprises a first roller track, a second roller track, and a linking roller track, which links the first and second roller tracks. Each of the first and second roller tracks comprises two side walls and plural rollers, each of which has an axis and each of which is supported between the side walls so as to be rotatable about its axis. The linking roller track comprises two side walls and a roller or plural rollers, each of which has an axis and each of which is supported between the side walls so as to be rotatable about its axis.

Each side wall of the linking roller track has a first extension, which is attached to an end portion of a respective one of the side walls of the first roller track. Each side wall of the linking roller track has a second extension, which is attached to an end portion of an associated one of the side walls of the second roller track.

Preferably, each such extension is flush with an inside surface of the end portion to which said same extension is attached. Preferably, each such extension is attached to the end portion of the associated one of the side walls, via a bolt or bolts. Preferably, the bolts attaching the respective extensions pass through elongate slots in the respective extensions.

In an embodiment illustrated in the accompanying drawings and described hereinbelow, each roller of each of the first, second, and linking roller tracks is supported so as to be freely rotatable about the axis of said roller.

### BRIEF DESCRIPTION OF THE DRAWINGS

FIG. 1 is a fragmentary, longitudinal, sectional view, which is taken through a roller track assembly embodying this invention, along a vertical plane, in a lateral direction.

FIG. 2 is a lateral, sectional view, which is taken along line 2-2 of FIG. 1, in a longitudinal direction indicated by arrows. Further, in FIGS. 1 and 2, a supporting beam is illustrated broken lines.

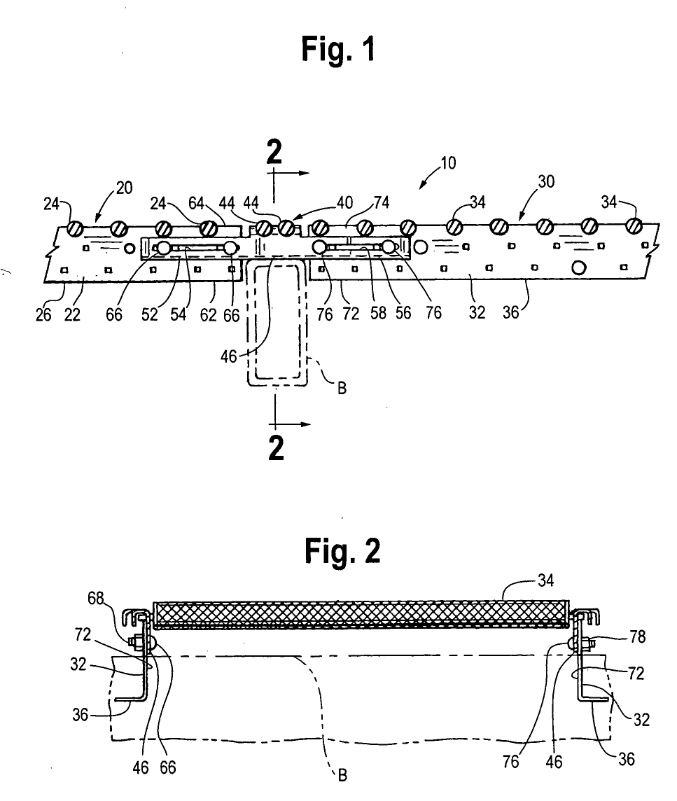

### DETAILED DESCRIPTION OF THE ILLUSTRATED EMBODIMENT

As illustrated, a roller track assembly 10 of the type noted above but of the improved construction provided by this invention comprises a first roller track 20, a second roller track 30, and a linking roller track 40, which links the first and second roller tracks 20, 30.

The first roller track 20, which is similar to roller tracks known heretofore except where the linking roller track 40 is attached to the first roller track 20, comprises two side walls 22 and plural rollers 24, four rollers 24 being illustrated, each of which has an axis and which are supported between the side walls 22 so as to be rotatable about their axes. The second roller track 30, which also is similar thereto and which is similar to the first roller track 20, comprises two side walls 32 and plural rollers 34, nine rollers 34 being illustrated, each of which has an axis and which are supported between the side walls 32 so as to be rotatable about their axes.

The linking roller track 40, which differs from the first and second roller tracks 20, 30, comprises two side walls 42 and plural rollers 44, two rollers 44 being illustrated, each of which has an axis and which are supported between the side walls 42 so as to be rotatable about their axes. Each side wall 42 of the linking roller track 40 has a first extension 52, which has an elongate slot 54 extending longitudinally, and a second extension 56, which has an elongate slot 58 extending longitudinally.

Being flush with an inside surface 62 of an end portion 64 of an associated one of the side walls 22 of the first roller track 20, the first extension 52 of each side wall 42 of the linking roller track 40 is bolted to the associated wall 22, via two bolts 66 passing through the elongate slot 54 of the first extension 52 of said side wall 42, each bolt 66 receiving an associated nut 68. Being flush with an inside surface 72 of an end portion 74 of an associated one of the side walls 32 of the second roller track 30, the second extension 56 of each side wall 42 of the linking roller track 40 is bolted to the associated wall 32, via two bolts 76 passing through the elongate slot 58 of the second extension 56 of the associated wall 42, each bolt 76 receiving an associated nut 78.

The side walls 22, 32, of the first and second roller tracks 20, 30, have lower, flanged edges 26, 36, which define a lower plane. The side walls 42 of the linking roller track 40 have lower edges 46, which define an upper plane that is spaced above the lower plane, so as to define, below the side walls 42 of the linking roller track 40 and between the near ends 28, 38, of the side walls 22, 32, of the first and second roller tracks 20, 30, a recess to accommodate a supporting beam B.

Although the linking roller track 40 is illustrated as having two rollers 44, the linking roller track 40 may be lengthwise extended so as to have more than two rollers 44. The elongate slots 54, 58, of the first and second extensions 52, 56, of the side walls 42 of the linking roller track 40 enable limited adjustability of the overall length of the roller track assembly.

As illustrated, the rollers 24, 34, 44, are supported so as to be rotatable freely about their axes. Alternatively, the rollers 24, 34, of the first and second roller tracks 20, 30, or the rollers 24, 34, 44, of all three roller tracks 20, 30, 40, are powered by means outside the scope of this invention. As illustrated, the roller track assembly 10 is level. Alternatively, the roller track assembly 10 is inclined.

1. A roller track assembly comprising a first roller track, a second roller track, and a linking roller track, which links the first and second roller tracks, wherein each of the first and second roller tracks comprises two side walls and plural rollers, each of which has an axis and each of which is supported between the side walls so as to be rotatable about its axis, wherein the linking roller track comprises two side walls and a roller or plural rollers, each of which has an axis and each of which is supported between the side walls so as to be rotatable about its axis, wherein each side wall of the linking roller track has a first extension, which is attached to an end portion of a respective one of the side walls of the first roller track, and wherein each side wall of the linking roller track has a second extension, which is attached to an end portion of an associated one of the side walls of the second roller track.

2. The roller track assembly of claim 1, wherein each said extension is flush with an inside surface of the end portion to which said same extension is attached.

3. The roller track assembly of claim 1, wherein each such extension is attached to the end portion of the associated one of the side walls, via a bolt or bolts.

4. The roller track assembly of claim 2, wherein each such extension is attached to the end portion of the associated one of the side walls, via a bolt or bolts.

5. The roller track assembly of claim 3, wherein the bolts attaching the respective extensions pass through elongate slots in the respective extensions.

6. The roller track assembly of claim 4, wherein the bolts attaching the respective extensions pass through elongate slots in the respective extensions.

7. The roller track assembly of claim 1, wherein each roller is supported so as to be freely rotatable about the axis of said roller.

8. The roller track assembly of claim 2, wherein each roller is supported so as to be freely rotatable about the axis of said roller.

9. The roller track assembly of claim 3, wherein each roller is supported so as to be freely rotatable about the axis of said roller.

10. The roller track assembly of claim 4, wherein each roller is supported so as to be freely rotatable about the axis of said roller.

11. The roller track assembly of claim 5, wherein each roller is supported so as to be freely rotatable about the axis of said roller.

12. The roller track assembly of claim 6, wherein each roller is supported so as to be freely rotatable about the axis of said roller.

13. The roller track assembly of any preceding claim, wherein the side walls of the first and second roller tracks have lower edges, which define a lower plane, and wherein the side walls of the linking roller track have lower edges, which define an upper plane that is spaced above the lower plane, so as to define, below the side edges of the linking roller track and between the near ends of the side walls of the first and second roller tracks, a recess to accommodate a supporting beam.
